(19) United States
(12) Patent Application Publication
(10) Pub. No.: US 2015/0128750 A1
(43) Pub. Date: May 14, 2015

(54) LINKAGE MECHANISM, ROBOT WORKING PLATFORM AND DESIGN METHOD FOR ROBOT WORKING PLATFORM

(71) Applicant: Industrial Technology Research Institute, Hsinchu (TW)

(72) Inventors: Po-Yi Li, Taipei City (TW); Tsung-Liang Wu, Hsinchu County (TW); Cheng-Chen Yang, Hsinchu City (TW); Jwu-Sheng Hu, Hsinchu City (TW)

(73) Assignee: Industrial Technology Research Institute, Hsinchu (TW)

(21) Appl. No.: 14/108,352

(22) Filed: Dec. 17, 2013

(30) Foreign Application Priority Data
Nov. 12, 2013 (TW) 102141077

(51) Int. Cl. B25J 18/00; G06F 17/50; B25J 17/00

(52) U.S. Cl. CPC B25J 18/00; B25J 17/00; G06F 17/5086; Y10S 901/28
USPC 74/490.05; 703/7; 901/28

(57) ABSTRACT

A linkage mechanism includes a first joint, a second joint, a first linkage and a second linkage. The two ends of the first linkage are respectively connected to the first joint and the second joint and the two ends of the second linkage are respectively connected to the first joint and the second joint, wherein when the linkage mechanism is subjected to an external force, the vibration phase of the first linkage is different from the vibration phase of the second linkage by π. In addition, a robot working platform and a design method for robot working platform are disclosed as well.

### CROSS-REFERENCE TO RELATED APPLICATION

This application claims the priority benefit of Taiwan application serial no. 102141077, filed on Nov. 12, 2013. The entirety of the above-mentioned patent application is hereby incorporated by reference herein and made a part of this specification.

### TECHNICAL FIELD

The present application relates to a linkage mechanism, a robot working platform and a design method for robot working platform.

### BACKGROUND

In general, a mechanical device in high-speed motion more likely produces vibration. For example, a mechanical device in high-speed motion, such as a robot, may get offset or rocking due to vibration. Thus, a machinery arm of the mechanical device during operation, such as during assembling a product, may produce assembling errors coming from the above-mentioned offset or rocking. In short, vibration would affect the working efficiency and working accuracy of a mechanical device.

In order to suppress the vibration produced by a mechanical device in high-speed motion, an additional anti-vibration device can be employed and disposed or a control method of the mechanical device can be adopted to get directly adjusted, but the additional anti-vibration device leads to extra manufacturing cost, while the adjustment control method requires complicated calculations.

### SUMMARY

The present application provides a linkage mechanism, which includes a first joint, a second joint, a first linkage and a second linkage. The two ends of the first linkage are respectively connected to the first joint and the second joint and the two ends of the second linkage are respectively connected to the first joint and the second joint, wherein when the linkage mechanism is subjected to an external force, the vibration phase of the first linkage is different from the vibration phase of the second linkage by π.

The present application provides a robot working platform, including a base, a stand and a linkage mechanism. The linkage mechanism is connected between the stand and the base. The linkage mechanism includes a first joint, a second joint, a first linkage, a second linkage and a third linkage. The two ends of the first linkage are respectively connected to the first joint and the second joint, the first linkage and the second linkage are pivoted to the stand through the first joint, and when the linkage mechanism is subjected to an external force, the difference of the vibration phases between the first linkage and the second linkage is π. The first linkage and the second linkage are pivoted to an end of the third linkage through the second joint and another end of the third linkage is pivoted to the base

The present application provides a design method for robot working platform, wherein the robot working platform includes a base, a stand and a linkage mechanism, the linkage mechanism is connected between the stand and the base, the linkage mechanism includes a first joint, a second joint, a first linkage, a second linkage and a third linkage, the two ends of the first linkage are respectively connected to the first joint and the second joint, and the two ends of the second linkage are respectively connected to the first joint and the second joint. The first linkage and the second linkage are pivoted to the stand through the first joint, the first linkage and the second linkage are pivoted to an end of the third linkage through the second joint and another end of the third linkage is pivoted to the base. The design method for robot working platform includes: obtaining a plurality of working parameters of the robot working platform; and adjusting a plurality of first design parameters of the first linkage and a plurality of second design parameters of the second linkage according to the working parameters so that when the linkage mechanism is subjected to an external force, the difference of the vibration phases between the first linkage and the second linkage is π.

In order to make the features and advantages of the present application more comprehensible, the present application is further described in detail in the following with reference to the embodiments and the accompanying drawings.

### BRIEF DESCRIPTION OF THE DRAWINGS

FIG. 1 is a schematic diagram of a robot working platform according to an embodiment of the application.

FIGS. 2A-2C are cross-section diagrams of the first linkage according to a plurality of embodiments of the application.

FIGS. 3A-3E are cross-section shape diagrams of the first linkage according to a plurality of embodiments of the application.

### DETAILED DESCRIPTION OF DISCLOSED EMBODIMENTS

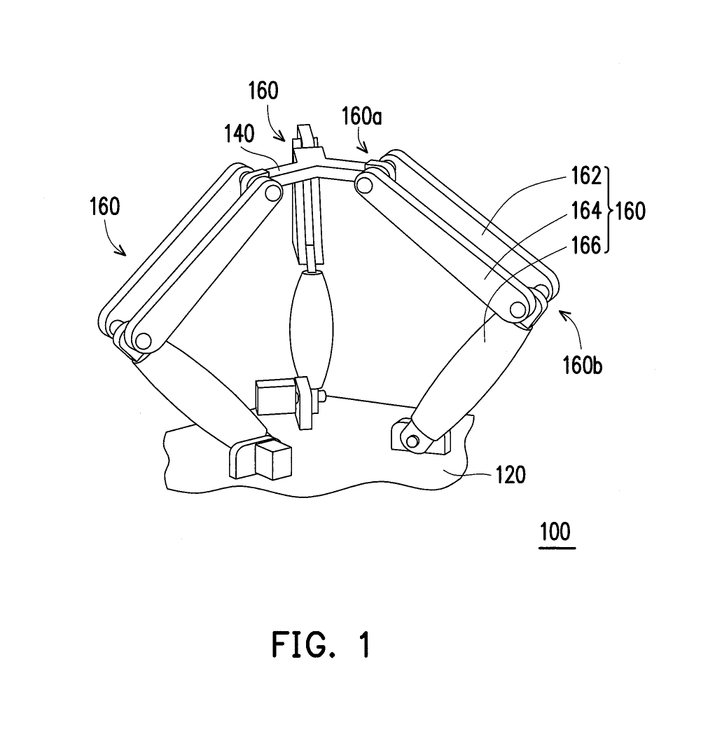

FIG. 1 is a schematic diagram of a robot working platform according to an embodiment of the application. Referring to FIG. 1, a robot working platform 100 includes a base 120, a stand 140 and three linkage mechanisms 160, in which each the linkage mechanism 160 is connected to the stand 140 and the base 120. The robot working platform 100 of the embodiment is, for example, a parallel-link delta robot platform, which the present application is not limited to. The robot working platform can be also a parallel kinematic machine (PKM). Each the linkage mechanism 160 can be respectively connected to a driving device to drive the linkage mechanism itself for running to further make the robot working platform 100 for working. It should be noted that the three linkage mechanisms 160 in the embodiment have similar design, thus only one of the linkage mechanisms 160 is explained as an example.

Referring to FIG. 1, the linkage mechanism 160 includes a first joint 160a, a second joint 160b, a first linkage 162, a second linkage 164 and a third linkage 166. The two ends of the first linkage 162 are respectively connected to the first joint 160a and the second joint 160b, and the two ends of the second linkage 164 are respectively connected to the first joint 160a and the second joint 160b. Specifically, the first linkage 162 and the second linkage 164 are pivoted to the stand 140 through the first joint 160a, the first linkage 162 and the second linkage 164 are pivoted to an end of the third linkage 166 through the second joint 160b, while the other end of the third linkage 166 is pivoted to the base 120. When the linkage mechanism 160 is subjected to an external force, the difference of the vibration phases between the first linkage 162 and the second linkage 164 is π, so that the amplitude direction of the first linkage 162 is just opposite to the amplitude direction of the second linkage 164, which enables to make the amplitude of the first linkage 162 and the amplitude of the second linkage 164 get counteraction after the resultant to achieve the vibration-suppression effect by reverse actions.

It is assumed the first linkage 162 or the second linkage 164 in the embodiment can be simplified to an ideal vibration system of mass and spring damper. The vibration equation of the system during free vibrating can be expressed with a second-order ordinary differential equation as follows:

m\ddot{X}+c\dot{X}+kX=0 (1)

The relationship X(t) between the displacement X and the time t can be derived from formula (1). In formula (1), m is mass, c is damping coefficient and k is stiffness coefficient. To obtain the solution of formula (1), the formula can be rewritten as an eigenvalue equation:

mλ²+cλ+k=0 (2)

where the solution thereof can be expressed with

$${λ}_{12} = \frac{- c \pm \sqrt{{c}^{2} - 4 mk}}{2 m} ,$$

in which it is defined that

$$α = \frac{c}{2 m} and ω = \frac{\sqrt{4 mk - {c}^{2}}}{2 m} .$$

Assuming the vibration system of mass and spring damper is an over damping system, then, 4mk−c²> in formula (2), i.e., ω*>0, wherein ω* is natural frequency. At the time, the solution of formula (2) can be expressed with λ₁₂=−α±iω*. The general solution of formula (2) is X(t)=Ce^{-αt} cos(ω*t−δ). Further assuming the initial condition of the system is: X(0)=X₀=A and \dot{X}(0)=\dot{X}₀=ωₙB, in which C=\sqrt{A²+B²} and

$$δ = {tan}^{- 1} ( \frac{B}{A} ) ,$$

the displacement X(t) can be expressed with:

X=A sin(ωₙt−φ)+B cos(ωₙt−φ) (3)

wherein φ is phase angle, ωₙ is natural frequency, and φ can be obtained from the interim phase angle in the calculation process.

In the embodiment, it is assumed that the initial condition of the first linkage 162 is \dot{X}₁₀, X₁₀, ω₁ₙ, wherein \dot{X}₁₀ is speed of the first linkage 162, X₁₀ is position of the first linkage 162 and ω₁ₙ is natural frequency of the first linkage 162; the initial condition of the second linkage 164 is \dot{X}₁₀, X₁₀, ω₂ₙ, wherein \dot{X}₁₀ is speed of the second linkage 164, X₁₀ is position of the second linkage 164 and ω₂ₙ is natural frequency of the second linkage 164. Since the first linkage 162 and the second linkage 164 move synchronously while the robot working platform 100 is moving so that they respectively have the same \dot{X}₁₀ and X₁₀. In addition, the two phases of the first linkage 162 and the second linkage 164 have a difference of π and it can be derived according to the above-mentioned condition:

$$φ = {tan}^{- 1} ( \frac{{\dot{X}}_{10}}{{X}_{10} {ω}_{1 n}} \pm π ) = φ = {tan}^{- 1} ( \frac{{\dot{X}}_{10}}{{X}_{10} {ω}_{2 n}} ) \qquad ( 4 )$$

It can be known from formula (4), the designer can make the phase difference between the first linkage 162 and the second linkage 164 as π design.

In the embodiment, in each of the linkage mechanisms 160 of the robot working platform 100, the first linkage 162 and the second linkage 164 have a phase difference of π, so that the robot working platform 100 can avoid the vibration by means of the above-mentioned counteraction of the reverse vibrations during the high-speed moving of the robot working platform 100 which further ensures the working efficiency and the working accuracy of the robot working platform 100. Moreover, the above-mentioned vibration-suppression way does not need an additional anti-vibration device or a complicated control method and can reduce the production cost and simplify the design.

Specifically, in the embodiment, the phase difference of π between the first linkage and the second linkage is achieved by means of adjusting the parameters of the first linkage 162 and the second linkage 164. In following, the design method for the robot working platform 100 and the parameters of the first linkage 162 and the second linkage 164 in the embodiment are explained.

First, a plurality of working parameters of the robot working platform 100 are obtained. In the embodiment, the working parameters include the working speed, load, kinematic mode, moving trajectory, acceleration and elastic rotation shaft of the robot working platform 100. For example, the designer can take the highest speed, the maximum load to be supported, the moving direction and the moving trajectory of the robot working platform 100 during running into account as the working parameters. Then, the first design parameters of the first linkage 162 and the second design parameters of the second linkage 164 are adjusted according to the above-mentioned working parameters.

In the embodiment, the first design parameters include the length, weight, material and cross-sectional area, inner diameter and outer diameter of the first linkage 162, and the second design parameters include the length, weight, material and cross-sectional area, inner diameter and outer diameter of the second linkage 164. The difference π of vibration phases between the first linkage 162 and the second linkage 164 can be obtained by adjusting the above-mentioned first design parameters and second design parameters, for example, by adjusting the proportion or the difference between the two design parameters.

For example, assuming both the first linkage 162 and the second linkage 164 are circle hollow tubes, the cross-sectional area of the first linkage 162 or the second linkage 164 would be related to the outer diameter and the tube-wall thickness of the hollow tube. Assuming the cross-sectional area of the first linkage 162 is A, then, A can be expressed with:

$${A}_{1} = π ( {r}_{1} t + \frac{{t}_{1}^{2}}{4} ) \qquad ( 5 )$$

wherein r₁ is the outer diameter of the first linkage 162, and t₁ is the tube-wall thickness of the first linkage 162. Assuming the cross-section shape of the first linkage 162 keeps unchanged along the length, the volume V₁ thereof can be obtained through timing formula (5) by the length L₁ of the first linkage 162:

$${V}_{1} = π ( {r}_{1} t + \frac{{t}_{1}^{2}}{4} ) {L}_{1} \qquad ( 6 )$$

Assuming the density of the first linkage 162 is ρ₁, the mass m₁ of the first linkage 162 can be expressed with m₁=V₁ρ₁. Then, the following formula can be obtained through timing the both sides of formula (6) by the natural frequency ω₁ₙ of the first linkage 162:

ω₁ₙ²m₁=ω₁ₙ²V₁ρ₁ (7)

Thereafter, by replacing the related variables with the Young's modulus E₁ and the expressions of the mass m₁ and the natural frequency ω₁ₙ of the first linkage 162, the following formula can be obtained:

ω₁ₙ²m₁=ω₁ₙ²V₁ρ₁ (8)

After formula (8) is substituted with formula (6) and simplifying, the following formula can be obtained:

$${ω}_{1 n}^{2} {V}_{1} {ρ}_{1} = \frac{3 {E}_{1} π {r}_{1}^{3} t}{{L}_{1}^{3}} \qquad ( 9 )$$

wherein L₁, ρ₁, ω₁ₙ and E₁ are known adjustable parameters, thus, formula (9) is a relation between the tube-wall thickness t₁ and the outer diameter r₁ of the first linkage 162.

Similarly to formula (9), there is a relation between the tube-wall thickness t₂ and the outer diameter r₂ of the second linkage 164. For the unchanged tube-wall thickness t₁ and the outer diameter r₁ of the first linkage 162, a set of parameters t₂ and r₂ can be derived. Further, the cross-sectional areas of the first linkage 162 and the second linkage 164 can be adjusted through t₁, r₁, t₂ and r₂. That is, the phase difference n between the first linkage 162 and the second linkage 164 can be obtained by design according to formula (4).

In more details, when the first design parameters and the second design parameters are respectively the cross-sectional areas of the first linkage 162 and the second linkage 164, the phase difference π of the vibrations between the first linkage 162 and the second linkage 164 can be obtained through a difference between the cross-sectional areas of the first linkage 162 and the second linkage 164. For example, when the cross-section shapes of the first linkage 162 and the second linkage 164 are unchanged along the lengths thereof, the phase difference π of the vibrations between the first linkage 162 and the second linkage 164 can be obtained by adjusting the proportion of the cross-sectional areas thereof.

In another way, the phase difference π of the vibrations between the first linkage 162 and the second linkage 164 can be obtained as well by adjusting the cross-sectional areas of the first linkage 162 and the second linkage 164 so as to make the cross-sectional areas respectively variable along the lengths of them.

In addition, the first linkage 162 and the second linkage 164 of the embodiment can be solid rods or hollow rods. When the first linkage 162 and the second linkage 164 are hollow tubes, the phase difference π of the vibrations between the first linkage 162 and the second linkage 164 can be obtained by adjusting the tube diameters of them. For example, the outer diameter of the first linkage 162 can be made to be greater than the outer diameter of the second linkage 164 or the inner diameter of the first linkage 162 can be made to be greater than the inner diameter of the second linkage 164. Or, by adjusting both the outer diameter and the inner diameter, that is the outer diameter of the first linkage 162 is greater than the outer diameter of the second linkage 164 and the inner diameter of the first linkage 162 is less than the inner diameter of the second linkage 164.

The first linkage 162 and the second linkage 164 have good elastic designs by adjusting the cross-sectional areas and the tube diameters thereof. In following more embodiments of the first linkage 162 are explained.

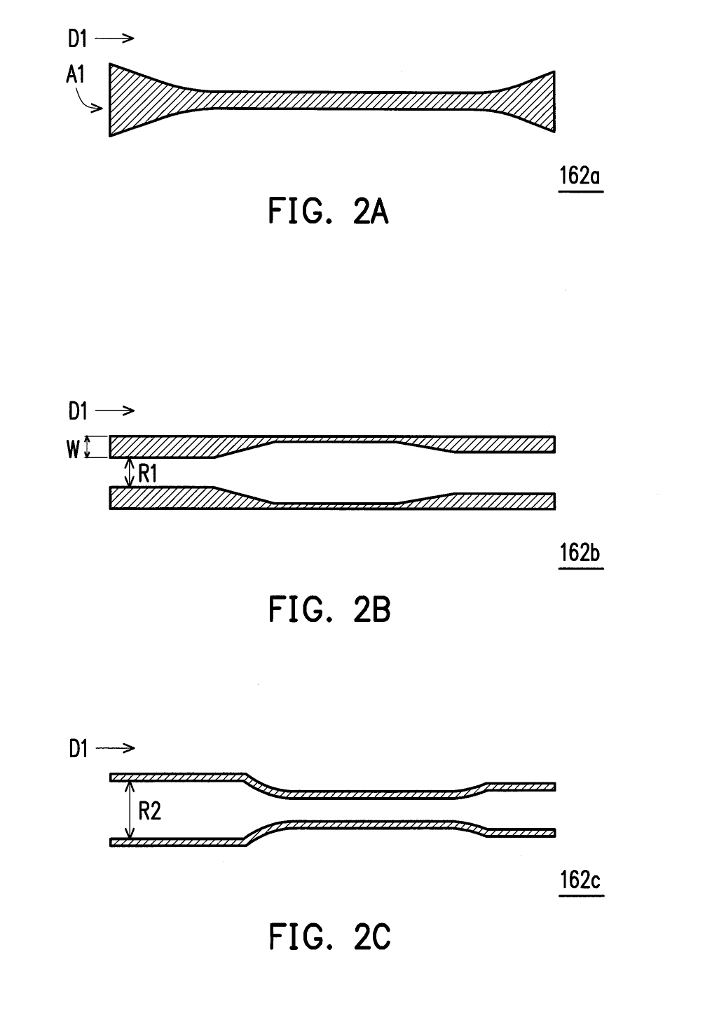

FIGS. 2A-2C are cross-section diagrams of the first linkage according to a plurality of embodiments of the application. It should be noted that although FIGS. 2A-2C are against the first linkage as an example, but it can be used for the second linkage as well. Referring to FIG. 2A, a first linkage 162a in the embodiment is a solid rod and the cross-sectional area A1 of the first linkage 162a is from small to large and then from large to small along the length direction D1. Referring to FIG. 2B, a first linkage 162b in the embodiment is a hollow rod and the inner diameter R1 of the first linkage 162b is from small to large and then from large to small along the length direction D1. In addition, the tube-wall thickness W of the first linkage 162b, at the portions thereof close to the two ends of the linkage, is greater than the rest portions. referring to FIG. 2C, a first linkage 162c in the embodiment is a hollow rod and the inner diameter R2 of the first linkage 162c is from large to small and then from small to large along the length direction D1 thereof.

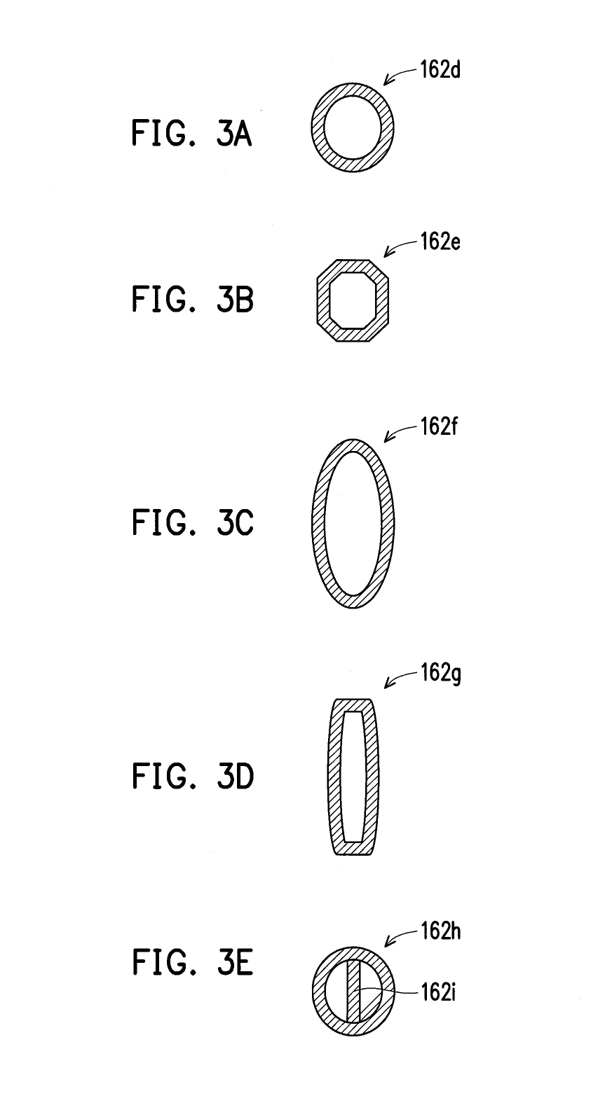

FIGS. 3A-3E are cross-section shape diagrams of the first linkage according to a plurality of embodiments of the application. It should be noted that although FIGS. 3A-3E are against the first linkage as an example, but it can be used for the second linkage as well. As shown by FIGS. 3A-3E, the cross-section shape of the first linkage can be circle, ellipse or polygon. In addition as shown by FIG. 3E, the first linkage 162h further includes a supporting part 162i disposed in the hollow tube.

In the embodiment, when the working parameters of the robot working platform 100 are set, the difference of the vibration phases between the first linkage 162 and the second linkage 164 when the linkage mechanism 160 is subjected to an external force is n by design through executing the above-mentioned steps of the design method to adjust the first design parameters and the second design parameters, so as to achieve the vibration-suppression effect.

In summary, in the linkage mechanism of the application, difference of the vibration phases between the first linkage and the second linkage is π, so that the amplitudes thereof can get counteraction to achieve the vibration-suppression effect. When the linkage mechanism is used to a robot working platform, the robot working platform can be avoided from the vibration affecting during high-speed running. As a result, the working efficiency and the working accuracy of the robot working platform is ensured.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A linkage mechanisms, comprising:
a first joint;
a second joint;
a first linkage, wherein two ends of the first linkage are respectively connected to the first joint and the second joint; and
a second linkage, wherein two ends of the second linkage are respectively connected to the first joint and the second joint, and when the linkage mechanism is subjected to an external force, the difference of the vibration phases between the first linkage and the second linkage is π.

2. The linkage mechanism as claimed in claim 1, wherein cross-section shapes of the first linkage and the second linkage comprise circle, ellipse or polygon.

3. The linkage mechanism as claimed in claim 1, wherein cross-section area of the first linkage is different from cross-section area of the second linkage.

4. The linkage mechanism as claimed in claim 1, wherein the cross-section area of the first linkage is changed along the length direction thereof and the cross-section area of the second linkage is changed along the length direction thereof.

5. The linkage mechanism as claimed in claim 1, wherein both the first linkage and the second linkage are hollow tubes.

6. The linkage mechanism as claimed in claim 5, wherein outer diameter of the first linkage is greater than outer diameter of the second linkage.

7. The linkage mechanism as claimed in claim 5, wherein inner diameter of the first linkage is greater than inner diameter of the second linkage.

8. The linkage mechanism as claimed in claim 5, wherein the outer diameter of the first linkage is greater than the outer diameter of the second linkage, and the inner diameter of the first linkage is less than the inner diameter of the second linkage.

9. The linkage mechanism as claimed in claim 1, wherein the first linkage and the second linkage have different materials.

10. A robot working platform, comprising:
a base;
a stand; and
a linkage mechanism, connected between the stand and the base; the linkage mechanism comprising:
a first joint;
a second joint;
a first linkage, wherein two ends of the first linkage are respectively connected to the first joint and the second joint; and
a second linkage, wherein two ends of the second linkage are respectively connected to the first joint and the second joint, the first linkage and the second linkage are pivoted to the stand through the first joint, and when the linkage mechanism is subjected to an external force, the difference of the vibration phases between the first linkage and the second linkage is π; and
a third linkage, wherein the first linkage and the second linkage are pivoted to an end of the third linkage through the second joint and another end of the third linkage is pivoted to the base.

11. The robot working platform as claimed in claim 10, wherein cross-section shapes of the first linkage and the second linkage comprise circle, ellipse or polygon.

12. The robot working platform as claimed in claim 10, wherein cross-section area of the first linkage is different from cross-section area of the second linkage.

13. The robot working platform as claimed in claim 10, wherein the cross-section area of the first linkage is changed along the length direction thereof and the cross-section area of the second linkage is changed along the length direction thereof.

14. The robot working platform as claimed in claim 10, wherein both the first linkage and the second linkage are hollow tubes.

15. The robot working platform as claimed in claim 14, wherein outer diameter of the first linkage is greater than outer diameter of the second linkage.

16. The robot working platform as claimed in claim 14, wherein inner diameter of the first linkage is greater than inner diameter of the second linkage.

17. The robot working platform as claimed in claim 14, wherein the outer diameter of the first linkage is greater than the outer diameter of the second linkage, and the inner diameter of the first linkage is less than the inner diameter of the second linkage.

18. The robot working platform as claimed in claim 10, wherein the first linkage and the second linkage have different materials.

19. A design method for robot working platform, wherein the robot working platform comprises a base, a stand and a linkage mechanism, the linkage mechanism is connected between the stand and the base, the linkage mechanism comprises a first joint, a second joint, a first linkage, a second linkage and a third linkage, two ends of the first linkage are respectively connected to the first joint and the second joint, two ends of the second linkage are respectively connected to the first joint and the second joint, the first linkage and the second linkage are pivoted to the stand through the first joint, the first linkage and the second linkage are pivoted to an end of the third linkage through the second joint and another end of the third linkage is pivoted to the base, and the design method for robot working platform comprises:
obtaining a plurality of working parameters of the robot working platform; and
adjusting a plurality of first design parameters of the first linkage and a plurality of second design parameters of the second linkage according to the working parameters so that when the linkage mechanism is subjected to an external force, the difference of the vibration phases between the first linkage and the second linkage is π.

20. The design method for robot working platform as claimed in claim 19, wherein the working parameters comprise working speed, load, kinematic mode, moving trajectory, acceleration and elastic rotation shaft of the robot working platform.

21. The design method for robot working platform as claimed in claim 19, wherein the first design parameters comprise length, weight and material of the first linkage and the second design parameters comprise length, weight and material of the second linkage.

22. The design method for robot working platform as claimed in claim 19, wherein the first design parameters comprise cross-sectional area of the first linkage, the second design parameters comprise cross-sectional area of the second linkage, and the step of adjusting the first design parameters of the first linkage and the second design parameters of the second linkage according to the working parameters comprises making the cross-sectional area of the first linkage unequal to the cross-sectional area of the second linkage.

23. The design method for robot working platform as claimed in claim 19, wherein the first design parameters comprise cross-sectional area of the first linkage, the second design parameters comprise cross-sectional area of the second linkage, and the step of adjusting the first design parameters of the first linkage and the second design parameters of the second linkage according to the working parameters comprises making the cross-section area of the first linkage changed along the length direction of the first linkage and making the cross-section area of the second linkage changed along the length direction of the second linkage.

24. The design method for robot working platform as claimed in claim 19, wherein both the first linkage and the second linkage are hollow tubes, the first design parameters comprise outer diameter of the first linkage, the second design parameters comprise outer diameter of the second linkage, and the step of adjusting the first design parameters of the first linkage and the second design parameters of the second linkage according to the working parameters comprises making the outer diameter of the first linkage greater than the outer diameter of the second linkage.

25. The design method for robot working platform as claimed in claim 19, wherein both the first linkage and the second linkage are hollow tubes, the first design parameter comprises inner diameter of the first linkage, the second design parameter comprises inner diameter of the second linkage, and the step of adjusting the first design parameters of the first linkage and the second design parameters of the second linkage according to the working parameters comprises making the inner diameter of the first linkage greater than the inner diameter of the second linkage.

26. The design method for robot working platform as claimed in claim 19, wherein both the first linkage and the second linkage are hollow tubes, the first design parameter comprises inner diameter and outer diameter of the first linkage, the second design parameter comprises inner diameter and outer diameter of the second linkage, and the step of adjusting the first design parameters of the first linkage and the second design parameters of the second linkage according to the working parameters comprises making the outer diameter of the first linkage greater than the outer diameter of the second linkage and the inner diameter of the first linkage less than the inner diameter of the second linkage.
